(19) United States
(12) Patent Application Publication
(10) Pub. No.: US 2014/0376121 A1
(43) Pub. Date: Dec. 25, 2014

(54) COLOR FILTER SUBSTRATE

(71) Applicant: Samsung Display Co., LTD., Yongin-City (KR)

(72) Inventor: Hyun-Ki KIM, Cheonan-si (KR)

(21) Appl. No.: 14/312,545

(22) Filed: Jun. 23, 2014

(30) Foreign Application Priority Data
Jun. 25, 2013 (KR) 10-2013-0072981

(51) Int. Cl. G02B 5/20; G02F 1/1335

(52) U.S. Cl. CPC G02B 5/201; G02F 1/133514
USPC 359/891

(57) ABSTRACT

A color filter substrate includes a substrate, a color filter and a plurality of dummy column spacer. The substrate has an effective area and an ineffective area which is adjacent to the effective area. The color filter is disposed on the substrate in the effective area. The plurality of dummy column spacers is formed from the same layer as the column spacers and the plurality of dummy column spacers are formed on the ineffective area and surrounds the effective area in the ineffective area.

### CROSS-REFERENCE TO RELATED APPLICATION(S)

This application claims priority under 35 USC §119 to Korean Patent Applications No. 10-2013-0072981, filed on Jun. 25, 2013, in the Korean Intellectual Property Office (KIPO), the contents of which are incorporated herein in its entirety by reference.

### BACKGROUND

1. Technical Field

Exemplary embodiments relate generally to a color filter substrate. More particularly, embodiments of the inventive concept relate to a color filter substrate which includes dummy column spacers.

2. Description of the Related Art

A flat panel display device is a display element which displays an image by controlling light intensity. The flat panel display is used in various electronic devices and various industrial fields because it has various advantages such as light weight, compact size, high resolution, large screen size, and low power consumption.

The flat panel display device includes a substrate on which a black matrix, a color filter, an electrode and a thin film transistor (TFT) are formed. The flat panel display is classified into a liquid crystal display device (LCD) which displays an image by controlling a liquid crystal molecules which is driven by an electric field applied to the liquid crystal molecules, an organic light emitting diode display (OLED) which displays an image by controlling a current path through an organic light emitting diode, and an electro phoretic display device which displays an image by controlling a light shutter element which is driven by a voltage.

The manufacturing of flat panel display device includes a process for forming an alignment layer of the liquid crystal display device, a process for forming the organic light emitting element of the organic light emitting diode display and a process for arranging the electro phoretic element of the electro phoretic display device. During these processes, fine particles may be attached on the substrate. The particles attached on the substrate may cause significant defects and, thus, a yield of products may be decreased.

### SUMMARY

Some exemplary embodiments provide a color filter substrate which prevents particles from attaching on the substrate.

According to some example embodiments, a color filter substrate includes a substrate, a color filter and a plurality of dummy column spacer. The substrate has an effective area and an ineffective area which is adjacent to the effective area. The color filter is disposed on the substrate in the effective area. The plurality of dummy column spacers is formed of the same layer as column spacers, and the dummy column spacers are formed on the ineffective areas and surrounds the effective area in the ineffective area.

In example embodiments, the dummy column spacers may be spaced apart from an edge of the substrate by more than 5000 um.

In example embodiments, the dummy column spacers may be spaced apart from a center of a seal line by more than 3500 um.

In example embodiments, cross sections of the dummy column spacers may have a trapezoidal shape having a predetermined height and interval.

In example embodiments, the dummy column spacers may have a circular shape when viewed from the top.

In example embodiments, the dummy column spacers may have a trapezoidal shape having a predetermined height and interval.

In example embodiments, the dummy column spacers may have a checker board shape when viewed from the top.

In example embodiments, the dummy column spacers may have a rectangular shape having long sides tilted to a rubbing angle.

In example embodiments, the dummy column spacers may have a rectangular shape and a space between the dummy column spacers on a first row overlaps a dummy column spacer on a second row

Therefore, a dummy column spacer is formed in an ineffective area to prevent particles from attaching on the ineffective areas in a color filter substrate. A defect ratio of the color filter substrate on which the dummy column spacer is formed in the ineffective area may be decreased, and a yield may be increased.

### BRIEF DESCRIPTION OF THE DRAWINGS

Illustrative, non-limiting exemplary embodiments will be more clearly understood with reference to the following detailed description and accompanying drawings.

FIG. 1 is a perspective view illustrating a liquid crystal display panel according to one example embodiment of present invention.

FIG. 2 is a plan view illustrating a liquid crystal display device divided from the liquid crystal display panel illustrated in FIG. 1.

FIG. 3A is a plan view illustrating a color filter substrate according to one example embodiment of present invention.

FIG. 3B is a plan view illustrating a portion ‘R1’ of FIG. 3A.

FIG. 3C is a plan view illustrating a portion ‘R2’ of FIG. 3A.

FIG. 3D is a plan view illustrating a portion ‘R3’ of FIG. 3A.

FIG. 4A is a plan view illustrating a dummy column spacer according to one example embodiment of present invention.

FIG. 4B is a cross-sectional view taken along a line A-A′ of FIG. 4A.

FIG. 5A is a plan view illustrating a dummy column spacer according to another example embodiment of the present invention.

FIG. 5B is a cross-sectional view taken along a line B-B′ of FIG. 5A

FIG. 6A is a plan view illustrating dummy column spacer according to other example embodiment of the present invention.

FIG. 6B is a cross-sectional view taken along a line C-C′ of FIG. 6A

FIG. 7A is a plan view illustrating a dummy column spacer according to other example embodiment of the present invention.

FIG. 7B is a cross-sectional view taken along a line D-D′ of FIG. 7A.

FIG. 8A is a plan view illustrating a dummy column spacers according to other example embodiment of the present invention.

FIG. 8B is a cross-sectional view taken along a line E-E′ of FIG. 8A.

### DETAILED DESCRIPTION OF THE EMBODIMENTS

Various exemplary embodiments will be described more fully hereinafter with reference to the accompanying drawings, in which some example embodiments are shown. The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can either be directly connected or coupled to the other element or formed with intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

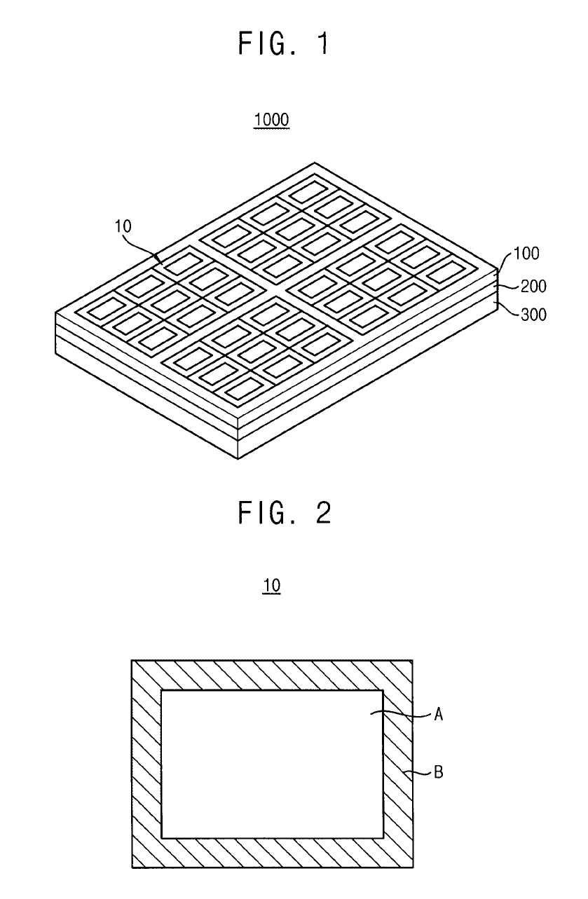

FIG. 1 is a perspective view illustrating a liquid crystal display panel according to one example embodiment of present invention and FIG. 2 is a plan view illustrating the liquid crystal display device divided from the liquid crystal display panel illustrated in FIG. 1.

Referring to FIG. 1, a liquid crystal display panel 1000 includes a color filter substrate 100, a thin film transistor (TFT) substrate 300 on which a thin film transistor and a pixel electrode are formed, and a liquid crystal layer 200 which is disposed between the color filter substrate 100 and the thin film transistor substrate 300.

The color filter substrate 100 is used in a flat panel display device. For example, the color filter substrate 100 may be used in a liquid crystal display device, an electro-phoretic display device and an OLED device.

Hereinafter, the method for manufacturing the liquid crystal display device 10 will be explained in detail. The color filter substrate 100 and the thin film transistor substrate 300 are formed, and an alignment layer is coated on the substrates and a rubbing treatment is performed. A sealant which is a thermo-setting resin or an ultraviolet ray curable resin is coated along a periphery of the color filter substrate 100 or the thin film transistor substrate 300. The color filter substrate 100 and the thin film transistor substrate 300 are laminated by a heat and a pressure. After injecting liquid crystals into the gap between the color filter substrate 100 and the thin film transistor substrate 300 through an opening in a seal pattern, the opening in the seal pattern is sealed. The liquid crystal display panel 1000 is divided into a plurality of liquid crystal display device 10 by a scribing process. A process for forming the liquid crystal layer may be performed by a one-drop-filling method.

Referring to FIG. 2, the liquid crystal display device 10 has an effective area A on which pixel units are formed and an ineffective area B on which pixel units are not formed. A frame-shaped seal line is formed surrounding on the ineffective area B. Dummy column spacers are formed in the ineffective area B according to example embodiments of prevent invention.

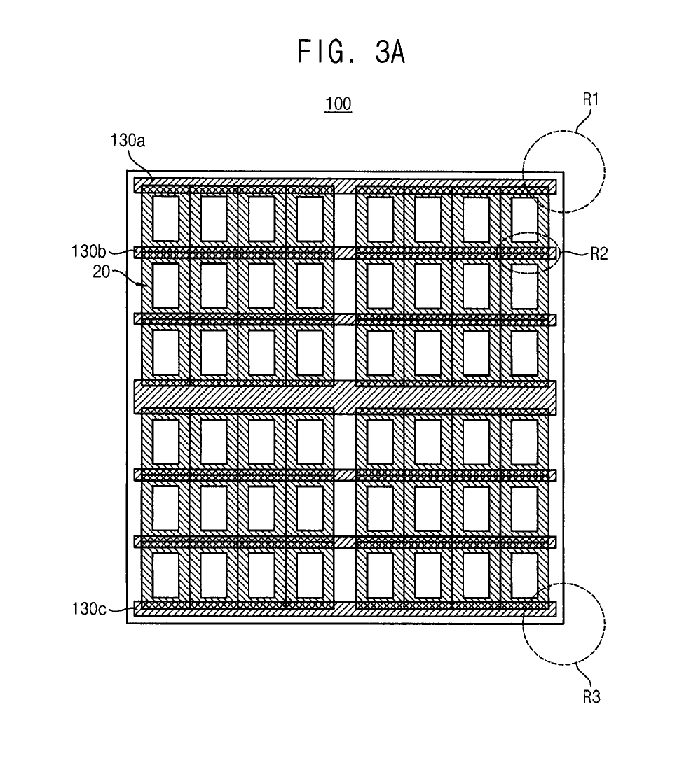

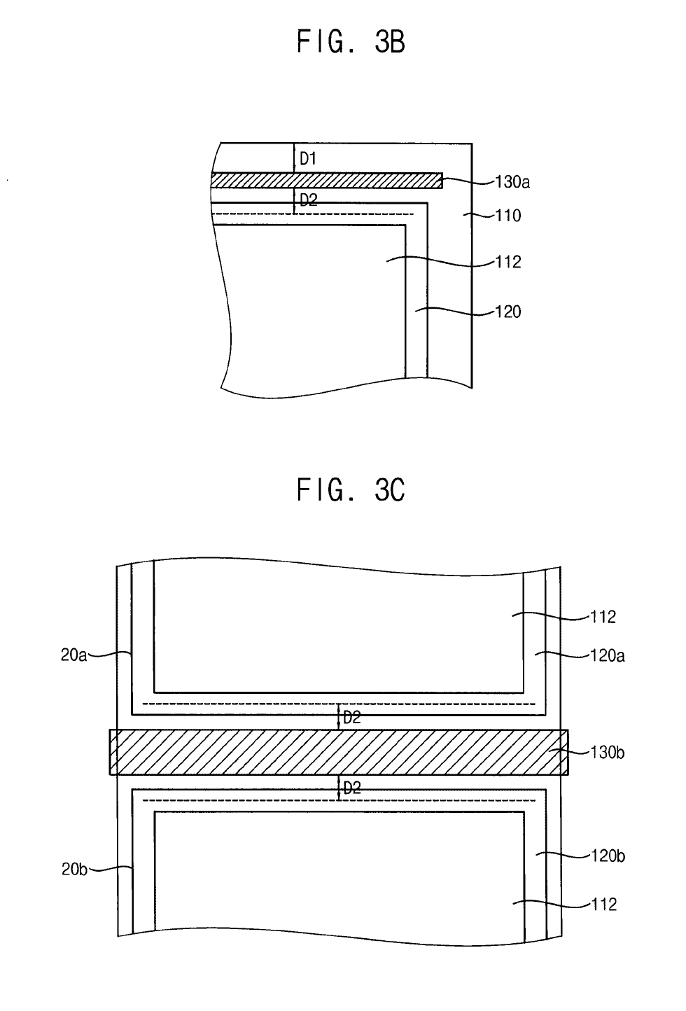

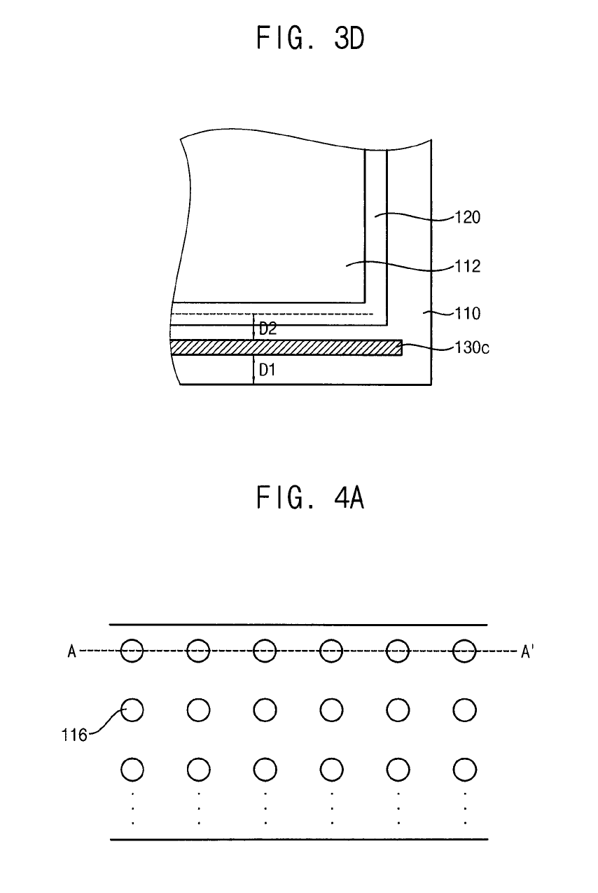

FIG. 3A is a plan view illustrating a color filter substrate according to one exemplary embodiment of the present invention, FIG. 3B is a plan view illustrating a portion ‘R1’ of FIG. 3A, FIG. 3C is a plan view illustrating a portion ‘R2’ of FIG. 3A, and FIG. 3D is a plan view illustrating a portion ‘R3’ of FIG. 3A.

Referring to FIG. 3A, a color filter substrate 100 is manufactured by forming a color filter layer which includes a color filter, an overcoat layer, a common electrode and a seal line on the substrate. The substrate may be a glass or a plastic.

A plurality of cells 20 may be formed on the color filter substrate 100 to manufacture a plurality of liquid crystal display device.

The dummy column spacers are formed on a first spacer area 130a which is in an upper edge of the color filter substrate 100. The dummy column spacers are formed on a second spacer area 130b which is between cells 20. Further, the dummy column spacers are formed on a third spacer area 130c which is in a lower edge of the color filter substrate 100. The dummy column spacers are performed as a barrier which prevents particles from attaching on the effective areas during a rubbing process. Particles are prevented from flowing into the effective area by the dummy column spaces. Further, the dummy column spacers do not have an effect on a display quality because the dummy column spacers are formed in the ineffective area and are cut during a scribing process.

Referring to FIG. 3B, the first spacer area 130a may be disposed apart from the upper edge of the color filter substrate 110 by more than 5000 um D1. When a distance between the color filter which is formed in the effective area and the first spacer area 130a is too far, an effect of preventing the particles from attaching on the effective areas may be decreased. Thus, the dummy column spacers may be spaced apart from the upper edge of the color filter substrate 110 by more than 5000 um D1.

Further, the first spacer area 130a may be disposed apart from a center of the seal line 120 by more than 3500 um D2. When the distance D2 between the first spacer area 130a and the seal line 120 is maintained properly, the dummy column spacers may not effect on the effective area and a lamination process of the color filter substrate and the thin film transistor substrate is performed stably.

For example, when a distance from the upper edge of the color filter substrate 110 to the center of the seal line 120 is 12000 um, the first spacer area 130a may be disposed at 5000 um˜8500 um from the upper edge of the color filter substrate 110.

Referring to FIG. 3C, the second spacer area 130b may be disposed apart from the center of the seal line 120a and 120b by more than 3500 um D2. When the distance D2 between the second spacer area 130b and the seal line 120a and 120b is maintained properly, the dummy column spacers may not effect on the effective area and the lamination process of the color filter substrate and the thin film transistor substrate is performed stably.

For example, a distance from a center of the seal line 120a which is on a upper cell 20a and a center of the seal line 120b which is on a down cell 20b is 12000 um, the second spacer area 130b may be disposed at 3500 um˜8500 um from the center of the seal line 120a which is on a upper cell 20a.

Referring to FIG. 3D, the third spacer area 130c may be disposed apart from the lower edge of the color filter substrate 110 by more than 5000 um D1. When a distance between the color filter which is formed in the effective area and the third spacer area 130c is too far, an effect of preventing the particles from attaching on the effective area may be decreased.

Further, the dummy column spacers may be spaced apart from a center of the seal line 120 by more than 3500 um D2. When the distance D2 between the third spacer area 130c and the seal line 120 is maintained properly, the dummy column spacers may not effect on the effective area and the lamination process of the color filter substrate and the thin film transistor substrate is performed stably.

For example, a distance from the lower edge of the color filter substrate 110 to the center of the seal line 120 is 12000 um, the third spacer area 130c may be disposed at 5000 um˜8500 um from the lower edge of the color filter substrate 110.

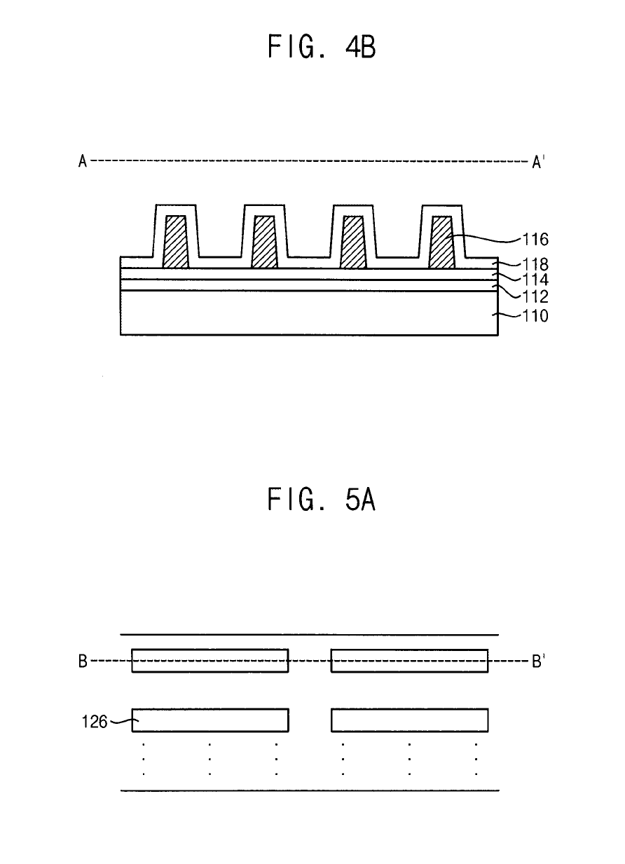

FIG. 4A is a plan view illustrating a dummy column spacer according to one exemplary embodiment of present invention and FIG. 4B is a cross-sectional view taken along a line A-A′ of FIG. 4A.

Referring to FIGS. 4A and 4B, the dummy column spacers 116 have a cylinder-shape having a predetermined height and interval according to one exemplary embodiment of present invention. The height and the interval of the dummy column spacers 116 may be decided to maintain a cell gap of the panel. The height of the dummy column spacers 116 may be the same height as the column spacers. The height of the dummy column spacers 116 may be higher than the height of the column spacers when the column spacers are formed on elevated regions of the effective areas. The interval of the dummy column spacers 116 may be the same interval as the column spacers. The dummy column spacers 116 may have a circular shape when viewed from the top. A size of the dummy column spacers 116 may not be limited, and may be changed according to the size of the color filter substrate 110 and device for the process. For example, a diameter of the dummy column spacer 116 may be about 16 um when viewed from the top.

The dummy column spacers 116 are formed in the first, the second and the third spacer area 130a, 130b and 130c illustrated in FIGS. 3A to 3D. The dummy column spacers 116 are spaced apart from each other at regular distance along a first imaginary line A-A′. The dummy column spacers 116 are disposed at regular distance along a second imaginary line perpendicular to the first imaginary line.

The dummy column spacers 116 are formed along at least one imaginary line. When the dummy column spacers 116 are formed in a high density, an effect of preventing the particles from attaching on the effective areas may be improved. But defects in cell gap may be occurred. When the dummy column spacers 116 are formed in a low density, an effect of preventing the particle from attaching on the effective areas may be decreased.

Referring to FIG. 4B, a cross-section A-A′ of the dummy column spacers 116 may be a trapezoidal shape cross sections and the dummy column spacers 116 may be formed on the same layer on which column spacers are formed. The column spacers are disposed in the effective area to maintain a cell gap.

The overcoat layer 114 is formed on the column spacers which are disposed in the effective area, thus, the overcoat layer 114 may be formed on the dummy column spacers 116 which are disposed in the ineffective area too.

Because the dummy column spacers 116 in the ineffective area and the column spacers in the effective area are formed of the same layer using the same process, an additional process is not necessary and only a mask revision is necessary to form the dummy column spacers 116 in the ineffective area.

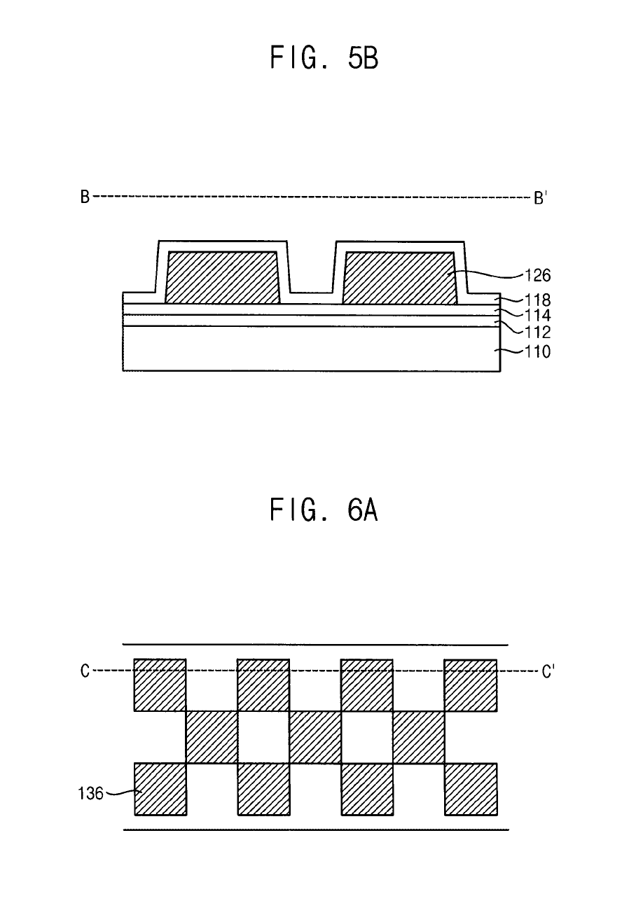

FIG. 5A is a plan view illustrating a dummy column spacer according to another exemplary embodiment of the present invention and FIG. 5B is a cross-sectional view taken along a line B-B′ of FIG. 5A

Referring to FIGS. 5A and 5B, the dummy column spacers 126 have a hexahedron shape having a predetermined height according to another exemplary embodiment of present invention. The dummy column spacers 126 may have a rectangular shape when viewed from the top. A width and height of the dummy column spacers 126 may not be limited, and may be changed according to the size of the color filter substrate 110 and device for the process. For example, a width of the dummy column spacer 126 may be about 2000 um and a height of the dummy column spacer 126 may be about 100 um when viewed from the top.

The dummy column spacers 126 are formed in the first, the second and the third spacer area 130a, 130b and 130c illustrated in FIGS. 3A to 3A. The dummy column spacers 126 are spaced apart from each other at regular distance along a first imaginary line B-B′. The dummy column spacers 126 are disposed at regular distance along a second imaginary line perpendicular to the first imaginary line.

The dummy column spacers 126 are formed along at least one line. When the dummy column spacers 126 are formed in a high density, an effect of preventing the particle from attaching on the effective area may be improved. But the defects in cell gap may be occurred. When the dummy column spacers 126 are formed in a low density, an effect of preventing the particle from attaching on the effective areas may be decreased.

Referring to FIG. 5B, a cross-section B-B′ of the dummy column spacers 126 may be a rectangular shape and the dummy column spacers 126 may be formed on the same layer on which column spacers are formed. The column spacers are disposed in the effective area to maintain a cell gap.

The overcoat layer 114 is formed on the column spacers which are disposed in the effective area, thus, the overcoat layer 114 may be formed on the dummy column spacers 126 which are disposed in the ineffective area too.

Because the dummy column spacers 116 in the ineffective area and the column spacers in the effective area are formed of the same layer using the same process, an additional process is not necessary and only a mask revision is necessary to form the dummy column spacers 116 in the in effective area.

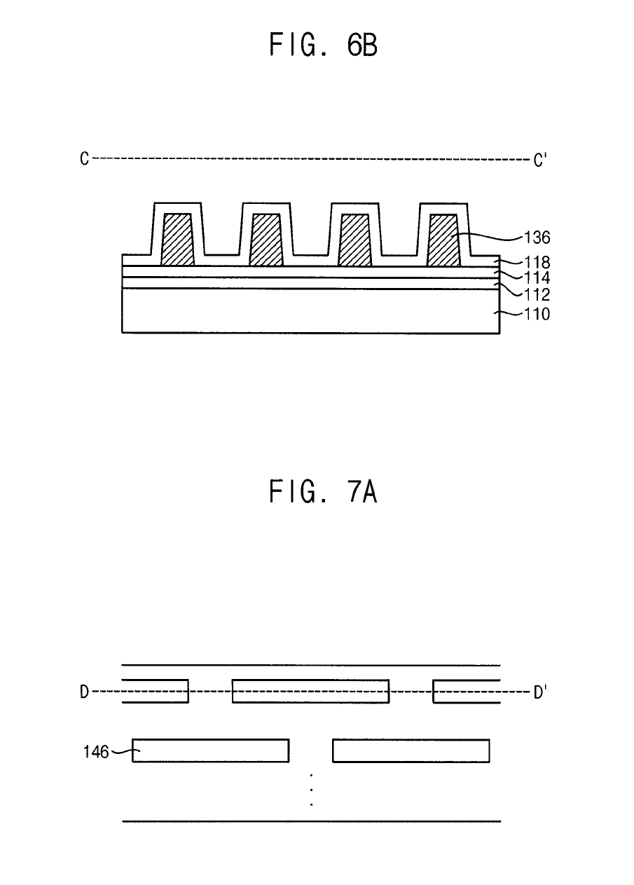

FIG. 6A is a plan view illustrating dummy column spacer according to other exemplary embodiment of the present invention and FIG. 6B is a cross-sectional view taken along a line C-C′ of FIG. 6A

Referring to FIGS. 6A and 6B, the dummy column spacers 136 have a hexahedron shape having a predetermined height according to other exemplary embodiment of present invention. The dummy column spacers 136 may have a checker board shape when viewed from the top. A width and height of the dummy column spacers 136 may not be limited, and may be changed according to the size of the color filter substrate 110 and device for the process. For example, a width and height of the dummy column spacer 136 may be about 50 um when viewed from the top

The dummy column spacers 136 are arranged in the first, the second and the third spacer area 130a, 130b and 130c illustrated in FIGS. 3A to 3A. The dummy column spacers 136 have a checker board pattern having a same length and width.

When the dummy column spacers 136 are formed in a high density, an effect of preventing the particle from attaching on the effective areas may be improved. But the defects in cell gap may be occurred. When the dummy column spacers 136 are formed in a low density, an effect of preventing the particle from attaching on the effective areas may be decreased.

Referring to FIG. 6B, a cross-section C-C′ of the dummy column spacers 136 may be a trapezoidal shape cross sections and the dummy column spacers 136 may be formed on the same layer on which column spacers are formed. The column spacers are disposed in the effective area to maintain a cell gap.

The overcoat layer 114 is formed on the column spacers which are disposed in the effective, thus, the overcoat layer 114 may be formed on the dummy column spacers 136 which are disposed in the ineffective area too.

Because the dummy column spacers 126 in the ineffective area and the column spacers in the effective area are formed of the same layer using the same process, an additional process is not necessary and only a mask revision is necessary to form the dummy column spacers 126 in the in effective area

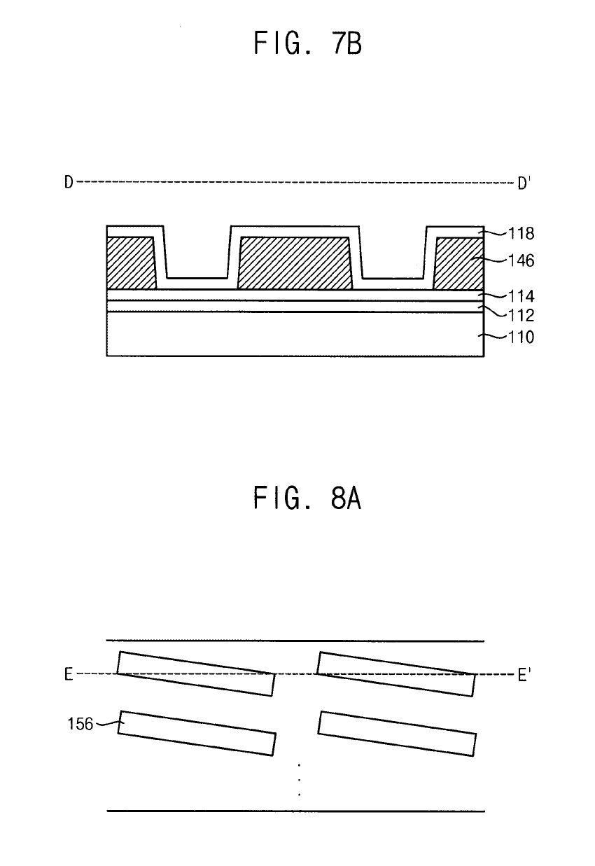

FIG. 7A is a plan view illustrating a dummy column spacer according to other exemplary embodiment of the present invention and FIG. 7B is a cross-sectional view taken along a line D-D′ of FIG. 7A.

Referring to FIGS. 7A and 7B, the dummy column spacers 146 have a hexahedron shape having a predetermined height according to other exemplary embodiment of present invention. The dummy column spacers 146 may have a rectangular shape when viewed from the top. A width and height of the dummy column spacers 146 may not be limited, and may be changed according to the size of the color filter substrate 110 and device for the process. For example, a width of the dummy column spacer 146 may be about 2000 um and a height of the dummy column spacer 146 may be about 100 um when viewed from the top.

The dummy column spacers 146 are arranged in a dotted line-shape in the first, the second and the third spacer area 130a, 130b and 130c illustrated in FIGS. 3A to 3A. The dummy column spacers 146 are spaced apart from each other at regular distance along a first imaginary line D-D′. The dummy column spacers 146 are spaced apart from each other at regular distance along a second imaginary line perpendicular to the first imaginary line. The dummy column spacers 146 disposed on a first row and the dummy column spacers 146 disposed on a second row are not in a same column. The space between the dummy column spacers 146 on a first row overlaps the dummy column spacer on the second row.

The dummy column spacers 146 are formed along at least one line. When the dummy column spacers 146 are formed in a high density, an effect of preventing the particle from attaching on the effective areas may be improved. But the defects in cell gap may be occurred. When the dummy column spacers 146 are formed in a low density, an effect of preventing the particle from attaching on the effective areas may be decreased.

Referring to FIG. 7B, a cross-section D-D′ of the dummy column spacers 146 may be a trapezoidal shape cross sections and the dummy column spacers 146 may be formed on the same layer on which column spacers are formed. The column spacers are disposed in the effective area to maintain a cell gap.

The overcoat layer 114 is formed on the column spacers which are disposed in the effective area, thus, the overcoat layer 114 may be formed on the dummy column spacers 146 which are disposed in the ineffective area too.

Because the dummy column spacers 146 in the ineffective area and the column spacers in the effective area are formed of the same layer using the same process, an additional process is not necessary and only a mask revision is necessary to form the dummy column spacers 146 in the ineffective area.

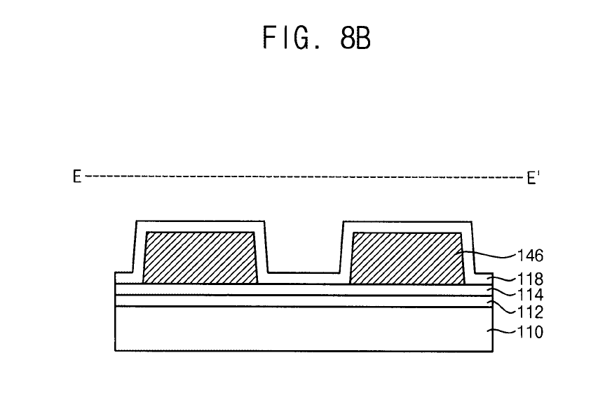

FIG. 8A is a plan view illustrating a dummy column spacers according to other exemplary embodiment of the present invention and FIG. 8B is a cross-sectional view taken along a line E-E′ of FIG. 8A.

Referring to FIGS. 8A and 8B, the dummy column spacers 156 have a hexahedron shape having a predetermined height according to another exemplary embodiment of present invention. The dummy column spacers 156 may have a rectangular shape when viewed from the top. A width and height of the dummy column spacer 156 may not be limited, and may be changed according to a size of the color filter substrate 110 and device for the process. For example, a width of the dummy column spacer 156 may be about 2000 um and a height of the dummy column spacer 156 may be about 100 um when viewed from the top.

The dummy column spacer 156s are tilted with respect to a side of the color filter substrate in the first, the second and the third spacer area 130a, 130b and 130c illustrated in FIGS. 3A to 3A. The dummy column spacers are tilted so that long sides of the dummy column spaces are tilted to a rubbing direction along a same row, and are spaced apart from each other by regular distance. The dummy column spacers 156 of a first row and the dummy column spacers 156 of a second row are spaced apart at regular distance.

The dummy column spacers 156 are formed along at least one line. When the dummy column spacers 156 are formed in a high density, an effect of preventing the particle from attaching on the effective areas may be improved. But the defect in cell gap may be occurred. When the dummy column spacers 156 are formed in a low density, an effect of preventing the particle from attaching on the effective areas may be decreased.

Referring to FIG. 8B, a cross-section E-E′ of the dummy column spacers 156 may be a trapezoidal shape cross sections and the dummy column spacers 156 may be formed on the same layer on which column spacers are formed. The column spacers are spaced in the effective area to maintain a cell gap.

The overcoat layer 114 is formed on the column spacers which are disposed in the effective area, thus, the overcoat layer 114 may be formed on the dummy column spacers 156 which are disposed in the ineffective area too.

Because the dummy column spacers 156 in the ineffective area and the column spacers in the effective area are formed on the same layer using the same process, an additional process is not necessary and only a mask revision is necessary to form the dummy column spacers 156 in the ineffective area.

As described, the dummy column spacers which are formed to prevent particles from attaching on the effective areas during the rubbing process may have a various shape and may be formed in the first, second and third space area 130a, 130b and 130c. The shape, location and density of the dummy column spacers may be selected considering a condition of the process, an environment of the process and a property of the panel.

The present inventive concept may be applied to any manufacturing method of flat display device. For example, the present inventive concept may be applied to a manufacturing method of various flat panel display devices that includes a liquid crystal display device, an electro phoretic display device and an organic light emitting diode display.

The foregoing is illustrative of exemplary embodiments and is not to be construed as limiting the scope of the inventive concept. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A color filter substrate comprising:
a substrate having an effective area and an ineffective area which is adjacent to the effective area;
a color filter disposed on the substrate in the effective area; and
a plurality of dummy column spacers formed from the same layer as the column spacers, the plurality of dummy column spacers being formed on the ineffective areas and surrounding the effective area.

2. The color filter substrate of claim 1, wherein the dummy column spacers are spaced apart from an edge of the substrate by more than 5000 um.

3. The color filter substrate of claim 2, wherein the dummy column spacers are spaced apart from a center of a seal line by more than 3500 um.

4. The color filter substrate of claim 3, wherein cross sections of the dummy column spacers have a trapezoidal shape having a predetermined height and interval.

5. The color filter substrate of claim 4, wherein the dummy column spacers have a circular shape when viewed from the top.

6. The color filter substrate of claim 4, wherein the dummy column spacers have a tetragonal shape when viewed from the top.

7. The color filter substrate of claim 2, wherein cross sections of the dummy column spacers have a trapezoidal shape having a predetermined height and interval.

8. The color filter substrate of claim 7, wherein the dummy column spacers have a circular shape when viewed from the top.

9. The color filter substrate of claim 7, wherein the dummy column spacers have a tetragonal shape when viewed from the top.

10. The color filter substrate of claim 1, wherein the dummy column spacers are spaced apart from a center of a seal line by more than 3500 um.

11. The color filter substrate of claim 10, wherein cross sections of the dummy column spacers have a trapezoidal shape having a predetermined height and interval.

12. The color filter substrate of claim 11, wherein the dummy column spacers have a circular shape when viewed from the top.

13. The color filter substrate of claim 11, wherein the dummy column spacers have a tetragonal shape when viewed from the top.

14. The color filter substrate of claim 13, wherein the dummy column spacers have a rectangular shape, a space between the dummy column spacers on a first row overlaps a dummy column spacer on a second row.

15. The color filter substrate of claim 1, wherein cross sections of the dummy column spacers have a trapezoidal shape having a predetermined height and interval.

16. The color filter substrate of claim 15, wherein the dummy column spacers have a circular shape when viewed from the top.

17. The color filter substrate of claim 15, wherein the dummy column spacers have a tetragonal shape when viewed from the top.

18. The color filter substrate of claim 17, wherein the dummy column spacers have a checker board shape when viewed from the top.

19. The color filter substrate of claim 17, wherein the dummy column spacers have a rectangular shape having long sides tilted to a rubbing angle.

20. The color filter substrate of claim 17, wherein the dummy column spacers have a rectangular shape, a space between the dummy column spacers on a first row overlaps a dummy column spacer on a second row.
